(19) United States
(12) Patent Application Publication
(10) Pub. No.: US 2020/0311123 A1
(43) Pub. Date: Oct. 1, 2020

(54) METHOD AND A SYSTEM FOR MULTIMODAL SEARCH KEY BASED MULTIMEDIA CONTENT EXTRACTION

(71) Applicant: Wipro Limited, Bangalore (IN)

(72) Inventor: Manjunath Ramachandra Iyer, Bangalore (IN)

(21) Appl. No.: 16/368,136

(22) Filed: Mar. 28, 2019

(30) Foreign Application Priority Data
Mar. 28, 2019 (IN) 201941012249

(51) Int. Cl. G06F 16/483; G06F 16/432; G06F 16/41; G06F 16/2457; G06N 20/00

(52) U.S. Cl. CPC G06F 16/483; G06F 16/432; G06Q 30/0631; G06F 16/24578; G06N 20/00; G06F 16/41

(57) ABSTRACT

A method and a system are described for multimodal search key based multimedia content extraction. The method includes receiving a multimedia content search request for a multimedia content, where the search request includes multimodal inputs in one or more fragments. The one or more fragments are interleaved to a composite fragment by removing overlapping content from the one or more fragments. The composite fragment is tagged to one or more attributes associated with the multimedia content based on a deep-learning of a context associated with the composite fragment. The method further includes identifying from a multimedia content database a correlation between the composite fragment and the multimedia content based on the context, where the multimedia content is stored in the multimedia content database. The method includes extracting the multimedia content identified from the multimedia content database.

### TECHNICAL FIELD

The present subject matter is related, in general, to information retrieval, but not exclusively, to a method and a system for multimodal search key based multimedia content extraction.

### BACKGROUND

In an era of interconnectivity and information, access to required information over wide area networks is primary, especially access to correct information. Considering a fact that internet is strewn with zillions of information, a correct direction to the required information is inevitable. State of art technology, for example Google™ search, allows only text based inputs and no provision for multimodal based input search other than a text based search, where a query includes words or phrases. Textual elements are compared to an index or other data structure to identify a set of documents such as web pages that include matching or semantically similar textual information, metadata, file names, or other textual representations. These mechanisms work relatively well for searching text-based documents, however they do not apply to image files and data. Further, in order to search the image files via a text-based query an image file must be associated with the textual elements, such as a title, a file name, or other metadata or tags. The search applications and mechanisms employed for the text based searching cannot search the image files based on content of an image and are limited to identifying search result images based on the data associated with images. The existing systems can render text and image outputs but as disjointed formats or fragments, that is the text based query renders text fragment and the image query renders image fragment.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to embodiments illustrated herein, there may be provided a method of multimodal search-key based multimedia content extraction. The method includes receiving, by a search key generator device, a multimedia content search request for a multimedia content where the multimedia content search request comprises multimodal inputs in one or more fragments and where the one or more fragments includes at least one of a text fragment, an image fragment, an audio fragment and a video fragment. It includes interleaving the one or more fragments to a composite fragment by removing overlapping content from the one or more fragments. It further includes identifying from a multimedia content database a correlation between the composite fragment and the multimedia content based on the context where the multimedia content is stored in the multimedia content database, and where searching for the correlation comprises comparing the context of the composite fragment to a context of the multimedia content and the method finally recommends one or more second products based on the emotion-score. The method then includes extracting the multimedia content identified from the multimedia content database based on comparing the context of the composite fragment to the context of the multimedia content.

According to embodiments illustrated herein, there may be provided a system for multi-modal search key based multimedia content extraction. The system includes a processor and a memory communicatively coupled to the processor, wherein the memory stores processor executable instructions, which on execution causes the processor to receive a multimedia content search request for a multimedia content, where the multimedia content search request includes multimodal inputs in one or more fragments and wherein the one or more fragments comprises at least one of a text fragment, an image fragment, an audio fragment and a video fragment. The search-key generator device interleaves the one or more fragments to a composite fragment by removing overlapping content from the one or more fragments. The search-key generator device tags the composite fragment to one or more attributes associated with the multimedia content based on a deep-learning of a context associated with the composite fragment. The search-key generator device identifies from a multimedia content database a correlation between the composite fragment and the multimedia content based on the context, where the multimedia content is stored in the multimedia content database, and where searching for the correlation comprises comparing the context of the composite fragment to a context of the multimedia content. The search-key generator then extracts the multimedia content identified from the multimedia content database based on comparing the context of the composite fragment to the context of the multimedia content.

According to embodiments illustrated herein, there may be provided a non-transitory computer-readable storage medium having stored thereon, a set of computer-executable instructions for causing a computer includes one or more processors to perform steps including receiving a multimedia content search request for a multimedia content, where the multimedia content search request comprises multimodal inputs in one or more fragments and where the one or more fragments comprises at least one of a text fragment, an image fragment, an audio fragment and a video fragment. It includes interleaving the one or more fragments to a composite fragment by removing overlapping content from the one or more fragments. It includes tagging the composite fragment to one or more attributes associated with the multimedia content based on a deep-learning of a context associated with the composite fragment. It then includes identifying from a multimedia content database a correlation between the composite fragment and the multimedia content based on the context, wherein the multimedia content is stored in the multimedia content database, and where searching for the correlation comprises comparing the context of the composite fragment to a context of the multimedia content. It includes extracting the multimedia content identified from the multimedia content database based on comparing the context of the composite fragment to the context of the multimedia content.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an exemplary environment in which various embodiments of the present disclosure may function.

FIG. 2 is a flowchart illustrating a method of multi-modal search-key based multimedia content extraction by fusing multi-modal user inputs, in accordance with some embodiments of the present disclosure.

FIG. 3 illustrates a block diagram of a search-key generator, in accordance with some embodiments of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

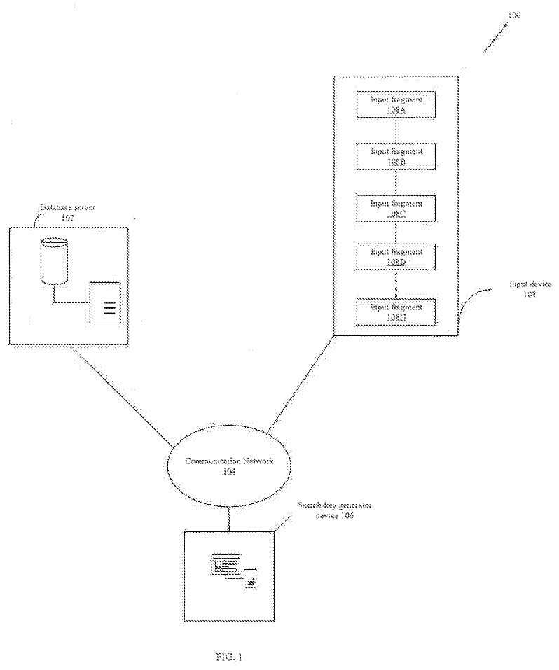

FIG. 1 is a block diagram that illustrates an exemplary environment 100 in which various embodiments of the present disclosure may function. The environment 100 may include a database server 102, a communication network 104, a search-key generator device 106, and an input device 108. The database server 102 may be a multimedia content database (not shown in the FIG. 1) configured to store at least text contents, images, audio clips, video clips, and graphic interchange format (GIF) contents. In an embodiment, the multimedia content database is populated iteratively every time, based on rendering a search request. The iterative population of the multimedia content database is based on deep learning of the search-key generator device (explained later). It may store data previously rendered to a user. The database server 102 may be connected to a public network, like a wide area network or a private network.

The database server 102 may communicate through a communication network 104 to a search-key generator device 106. The communication network 104 although represented as one communication network in FIG. 1 may in reality correspond to different communication networks under different contexts. For example, the communication network 104 may include various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 104 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

The input device 108 may be configured to receive user inputs for the multimedia content search request, where the multimedia content search request includes multimodal inputs in one or more fragments. The one or more fragments may include at least one of a text fragment, an image fragment, an audio fragment and a video fragment. In an embodiment, the input device 108 may be located remotely or may be housed in the search-key generator device 106 itself. For example, the input device 108, may be a human machine interface (HMI) to receive one or more multimodal inputs. The HMI configured to the input device 108 may receive from the user, multimodal inputs in one or more fragments where the one or more fragments includes at least one of a text fragment, an image fragment, an audio fragment and a video fragment. In other embodiments, the one or more fragments received via the input device 108, may be at least from a cell phone, laptop, tablet, and a desktop computer.

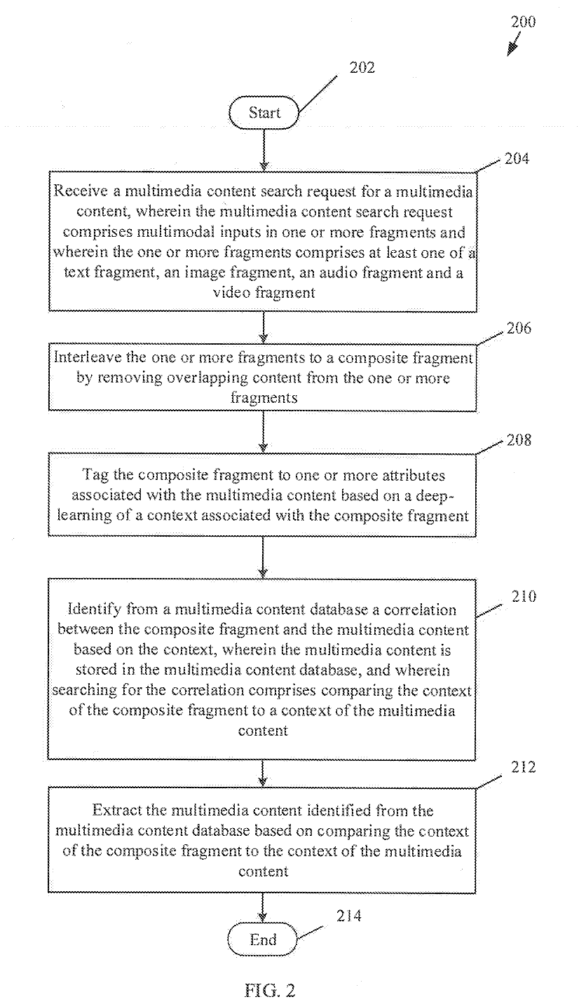

Once the multimodal inputs are received, they are sent to the search-key generator device 106 for multimodal search key based multimedia content extraction. The search-key generator device 106 may refer to a computing device that may include hardware and/or software that may be configured to perform one or more predetermined operations. The search-key generator device 106 may refer to a computing device or a software framework hosting an application or a software service. The search-key generator device 106 may perform one or more operations through one or more units (explained in detail in FIG. 2). The one or more operations may include receiving a multimedia content search request for a multimedia content, where the multimedia content search request comprises multimodal inputs in one or more fragments and where the one or more fragments comprises at least one of a text fragment, an image fragment, an audio fragment and a video fragment. The one or more operations further includes interleaving the one or more fragments to a composite fragment by removing overlapping content from the one or more fragments, tagging the composite fragment to one or more attributes associated with the multimedia content based on a deep-learning of a context associated with the composite fragment, identifying from a multimedia content database a correlation between the composite fragment and the multimedia content based on the context, where the multimedia content is stored in the multimedia content database, and where searching for the correlation comprises comparing the context of the composite fragment to a context of the multimedia content and finally extracting the multimedia content identified from the multimedia content database based on comparing the context of the composite fragment to the context of the multimedia content. In an embodiment, the search-key generator device 106 may be implemented to execute procedures such as, but not limited to, programs, routines, or scripts stored in one or more memories for supporting the hosted application or the software service. In an embodiment, the hosted application or the software service may be configured to perform one or more predetermined operations. The search-key generator device 106 may be realized through various types of servers such as, but are not limited to, a Java application server, a .NET framework application server, a Base4 application server, a PHP framework application server, or any other application server framework.

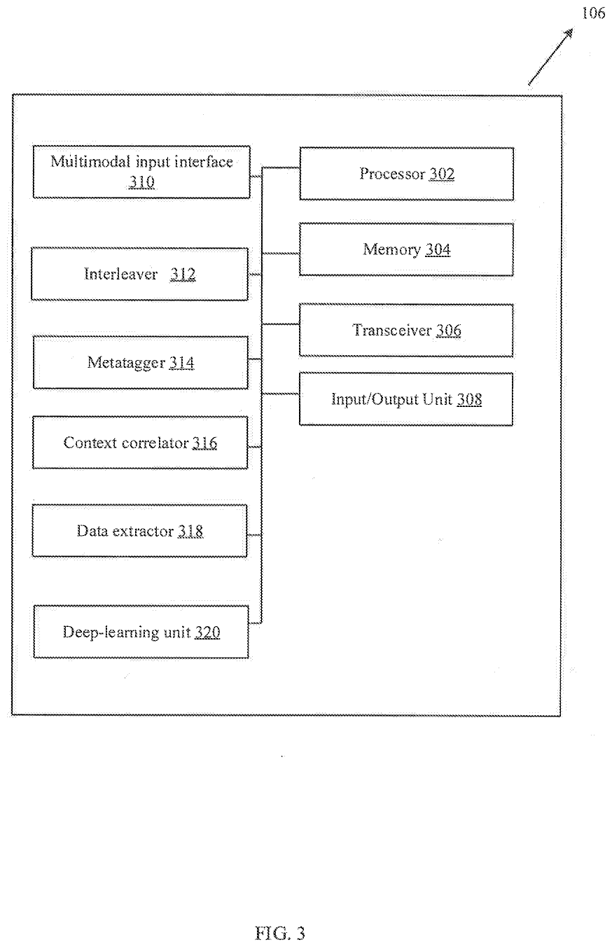

FIG. 2 is a method flow describing a multimodal search-key based multimedia content extraction. The method starts at 202. The method at 204 includes receiving, by a transceiver 306 (explained in FIG. 3), a multimedia content search request for a multimedia content, where the multimedia content search request comprises multimodal inputs in one or more fragments and where the one or more fragments comprises at least one of a text fragment, an image fragment, an audio fragment and a video fragment. Further, one of the multimodal inputs may act as a modifier to the multimedia content search request. Once the multimodal inputs are received, the method at step 206 includes interleaving the one or more fragments to a composite fragment by removing overlapping content from the one or more fragments. Once the composite fragment is created from the one or more fragments, the method at step 208 includes tagging the composite fragment to one or more attributes associated with the multimedia content based on a deep-learning of a context associated with the composite fragment. The one or more attributes associated with the multimedia content may include at least one of a name, a name of a place, a color, a verb, and an adjective.

The deep-learning may include determining the one or more attributes associated with the multimedia content, populating the multimedia content database based on the one or more attributes, assigning a common label to the composite fragment based on the common context, denominating weightages to the one or more fragments in the composite fragment based on the multimedia content search request, the attributes and the context and altering the weightages based on receiving the one of the multimodal inputs multimodal inputs as modifier. Once the composite fragment is tagged to the one or more attributes associated with the multimedia content, the method at step 210 identifies from a multimedia content database a correlation between the composite fragment and the multimedia content based on the context, where the multimedia content is stored in the multimedia content database, and where searching for the correlation includes comparing the context of the composite fragment to a context of the multimedia content. In an embodiment the multimedia content database which may be housed in the database server 102 may be connected to either the public network like a WAN or a private server. And once the correlation between the composite fragment and the multimedia content is identified, the method at step 212 extracts the multimedia content identified from the multimedia content database based on comparing the context of the composite fragment to the context of the multimedia content. In an embodiment, extraction comprises formatting the multimedia content extracted, where formatting further comprises at least synchronizing the audio fragment with the video fragment, and associating the text format and the image format to the synchronized audio format and video format. The method stops at step 214.

FIG. 3 illustrates a block diagram, in accordance with some embodiments of the present disclosure, of a search-key generator device 106, configured for multi-modal search key based multimedia content extraction. The search-key generator device 106 may include a processor 302, a memory 304, a transceiver 306, and an input/output unit 308. The search-key generator device 106 may further include a multimodal input interface 310, an interleaver 312, a metatagger 314, a context correlator 316, a data extractor 318 and a deep-learning unit 320.

As used herein, the terms unit or device refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the unit or device may be used to perform various miscellaneous functionalities of the multimodal search key based multimedia content extraction. It will be appreciated that such units may be represented as a single unit or a combination of different units. Furthermore, a person of ordinary skill in the art will appreciate that in an implementation, the one or more units may be stored in the memory 304, without limiting the scope of the disclosure. The said units when configured with the functionality defined in the present disclosure will result in a novel hardware.

In an embodiment the multimodal input interface 310 may receive via the transceiver 306 the multimedia content search request for the multimedia content, where the multimedia content search request comprises multimodal inputs in one or more fragments and where the one or more fragments comprises at least one of a text fragment, an image fragment, an audio fragment and a video fragment. In an embodiment, the multimodal input interface 310 may be configured with a natural language programming engine (NLP Engine not shown in FIG. 3) for machine level translation of the multimodal inputs. Once the multimodal inputs in one or more fragments are received, the interleaver 312 interleaves the one or more fragments to a composite fragment by removing overlapping content from the one or more fragments. For example, an audio input fragment and a video input fragment may both include audio waveforms.

The interleaver 312 may then filter overlapping audio waveform from the video fragment and interleave the audio fragment along with the video fragment. In another embodiment, one or more weightages may be assigned to the one or more fragments based on the multimedia content search request, the attributes of the multimedia content and the context of the multimedia content. The deep-learning unit 320 may be configured to denominate weightages to the one or more fragments based on pre-training. For example, if the request is about audio of Swarnil laughing, a higher weightage may be denominated to audio and then video (image frame) fragments and the composite fragment may be assigned a score that will tally to “laughing” and multimedia contents related to Swarnil laughing, along with image frames of Swarnil, if available in the multimedia content database, will be extracted. In the aforementioned exemplary scenario, the multimodal input may be an image fragment of Swarnil and just “Swarnil” as a text fragment.

Once the multimodal inputs in one or more fragments are interleaved, the metatagger 314 tags the composite fragment to one or more attributes associated with the multimedia content based on the deep-learning of a context associated with the composite fragment. The one or more attributes associated with the multimedia content comprises at least one of a name, a name of a place, a color, a verb, and an adjective. The one or more attributes of the multimedia content are determined by the deep-learning unit 320 from the multimedia content request query by the user and also in further embodiments the attributes of the multimedia content on request may also be stored in the multimedia content database. This may be because of previous search iterations. Based on the attributes learnt, the metatagger 314 tags by comparison, the one or more attributes to the common context of the composite fragment. The context of the composite fragment, for example, is a label which is assigned to the one or more fragments as a whole. The context is determined as a weighted average of the one or more composite fragments. And if the weighted average tallies a pre-determined threshold for a label, the particular label is attached to the composite fragment.

Once the label (the context) is attached to the composite fragment and the one or more attributes of the multimedia content is determined, the context correlator 316 then identifies from the multimedia content database a correlation between the composite fragment and the multimedia content based on the context, where the multimedia content is stored in the multimedia content database; and where searching for the correlation comprises comparing the context of the composite fragment to a context of the multimedia content. In an embodiment, the multimedia content database may be configured to connect to a public network like WAN or a private network. Once the correlation between the composite fragment and the multimedia content based on the context has been identified, the data extractor 318 extracts the multimedia content identified from the multimedia content database based on comparing the context of the composite fragment to the context of the multimedia content. The extraction further includes formatting the multimedia content extracted, where formatting further includes at least synchronizing the audio fragment with the video fragment, and associating the text format and the image format to the synchronized audio format and video format.

An editor unit (not shown in the FIG. 3) is configured with the data extractor 318 to format the multimedia content extracted before rendering to the user. For example, during the extraction of multimedia content there may be incomplete multimedia content, where incomplete multimedia content may encompass incomplete image, incomplete text, incomplete image frames, and incomplete audio waveforms and such incomplete data may cause the rendering of the multimedia content to be inaccurate. In an embodiment, the editor unit in the data extractor 318 deletes the incomplete content before rendering to the user. The editor unit relevantly merges the one or more fragments extracted and renders a complete meaningful content to the user. For example, a meaningful content may mean when a text fragment, is merged along an image fragment, where the text fragment describes the image fragment rendered. This merged text and the image fragment may be further merged with the audio fragment and the video fragment (if requested for in the query).

In an exemplary embodiment, an audio waveform constituting the audio fragment may further play and also along with an augmenting video fragment to elaborate the text fragment and image fragment extracted. This renders a complete information for the request generated by the user regarding the multimedia content. The editor unit may be further configured with a language selector to render information about the multimedia content in a language understandable to the user. For example, the user may want to listen to the sound quality of a Taylor™ guitar, and he also wants to find out the difference in sound qualities from the same guitar because of its use of nylon strings and steel strings. In this case, the user may only enter a text query and provide a particular picture of the guitar of his choice, which may be of a certain texture, wood material and color. The editor unit in the data extractor 318 may render information which may include a textual description of the guitar (made of the same wood finish as in the query and color as choice), provide images at different angles and in a small pop up window illustrate two videos which illustrates the guitar being played, simultaneously with the steel string and then with the nylon string. Thus as explained in the aforementioned example, the user will not have to separately query multiple times. The multimedia content rendered to the user, is auto customized, non-monomodal and data laden as per the search request made by the user.

The deep-learning unit 320 may further augment in the multimedia content rendered to the user and is configured to determine the one or more attributes associated with the multimedia content, populate the multimedia content database based on the one or more attributes, assign a common label to the composite fragment based on the common context, denominate weightages to the one or more fragments in the composite fragment based on the multimedia content search request, the attributes and the context, alter the weightages based on receiving the one of the multimodal inputs multimodal inputs as modifier.

The search-key generator device 106 via the deep-learning unit 320, may be pre-trained with the attributes of multimedia contents. For example, considering a picture of a mango, the training can be on the attributes, namely, a shape or contour of the mango, the variety of colors of a mango, peak ripe season of the mango, a geographical, connotation of the mango, classifying mango as a fruit and finally tagging the fruit as mango. When the user inputs the query mango as the text fragment (the type which is unknown to him) and inputs an image of the mango as image fragment, the search key-generator 106 after forming mango as the common context of the composite fragment, compares with the attributes of all the types of mango available in the multimedia content database. Post comparing, the type name and the attributes already available regarding the mango queried for may be rendered to the user along with the available details. As per the aforementioned example, after the multimedia content (data relevant to the mango as the example) has been rendered, the iteration is stored in the multimedia content database. In a further embodiment, if the data multimedia content queried for ends in an unsuccessful extraction, report may be automatically generated and stored as a special log in the database server 102.

The deep-learning unit 320 may be further configured to denominate weightages to the multimodal input in one or more fragments. For example, as aforementioned, if the input query is about textual query for a mango along with the image input, the audio and the video fragments may then take a lower weightage (even if there may be a relevant video or audio description available). In another exemplary embodiment, the query may be regarding the sound of a sonar signal from a submarine. In this case, a preference is assigned to an audio waveform as the audio fragment, the video fragment which practically may not exist is assigned zero and the text fragment may also take zero weightage. A sonar audio waveform if it may exist in the multimedia content database may be then rendered to the user.

In another exemplary embodiment, the multimodal inputs further acts as a modifier to the multimedia content search request. For example, the user may query for a blue shirt. Now, in an embodiment, the multimedia content database may be pre-trained to store one or more shades of color in hexadecimal format with base 16 or in decimal format with base 10, or otherwise called as RGB (RED, GREEN BLUE) format. For example, in RGB format, black may be represented as [0,0,0], white as [255, 255,255], navy blue as [0,0,128] and dark blue as [0,0,139]. The user may request to display a navy blue color shit. The deep-learning unit 320 as aforementioned is trained to identify attributes like adjectives. After the navy blue shirt has been rendered, the user may feel like checking out a darker shade and may need to input “darker than this” as text fragment. The search-key generator 106 may then search for a darker shade of blue color in the multimedia content database since it has already been pre-trained. If the same shirt with same attributes, as queried for is available in a darker shade of blue, like dark blue [0,0,139], may be rendered to the user. The aforementioned example, illustrates how attributes like adjectives act as modifiers to the input fragments and alter the weightage denominated to the composite fragment.

Taking the example forward, the user may query for sound of a jet engine. In this example, the audio waveform may take a higher weightage than an image of a jet engine itself. The user may now query for image of a jet engine. The audio waveform may now take a lower weightage and even if the audio waveform is available, a higher weightage may be denominated to the image input. If the audio waveform is available, it may be played as a background sound while the image of the jet engine is rendered.

The memory 304 may include suitable logic, circuitry, interfaces, and/or code that may be configured to store the set of instructions, which may be executed by the processor 302 for multi-modal search-key based multimedia content extraction. For example, the memory may store information on attributes of one or more multimedia content, previous iterations on multimedia content rendered. In an embodiment, the memory 304 may be configured to store one or more programs, routines, or scripts that may be executed in coordination with the processor 302. The memory 304 may be implemented based on a Random Access Memory (RAM), a Read-Only Memory (ROM), a Hard Disk Drive (HDD), a storage server, and/or a Secure Digital (SD) card.

The transceiver 306 may receive one or more multimodal in one or more fragments associated with the multimedia content, where the one or more fragments comprises at least one of a text fragment, an image fragment, an audio fragment and a video fragment. The transceiver 306 may implement one or more known technologies to support wired or wireless communication with the communication network 104. In an embodiment, the transceiver 306 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer.

The transceiver 306 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The search-key generator device 106 may further include an Input/Output (I/O) unit 308. The Input/Output (I/O) unit 208 may include suitable logic, circuitry, interfaces, and/or code that may be configured to receive an input or transmit an output. The input/output unit 308 may include various input and output devices that are configured to communicate with the processor 302. Examples of the input devices include, but are not limited to, a keyboard, a mouse, a joystick, a touch screen, a microphone, and/or a docking station. Examples of the output devices include, but are not limited to, a display screen and/or a speaker.

### Computer System

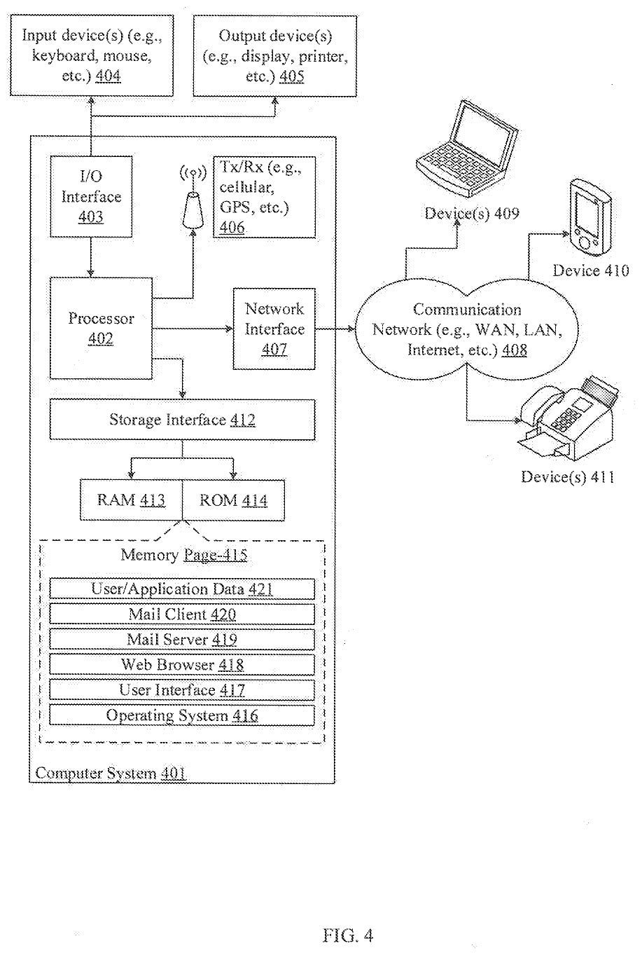

FIG. 4 illustrates a block diagram of an exemplary computer system for implementing embodiments consistent with the present disclosure. Variations of computer system 401 may be used for multi-modal search key based multimedia content extraction. The computer system 401 may comprise a central processing unit (“CPU” or “processor”) 402. Processor 402 may comprise at least one data processor for executing program components for executing user or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon™, Duron or Opteron, ARM's application, embedded or secure processors, IBM PowerPC®, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The 1/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMT), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with device(s) 409. These devices may include, without limitation, personal computer(s), server(s), fax machines, printers, scanners, various mobile devices such as cellular telephones, smartphones (e.g., Apple iPhone™, Smart TV, Android-based phones, etc.), tablet computers, eBook readers (Amazon Kindle, Nook, etc.), laptop computers, notebooks, gaming consoles (Microsoft Xbox™, Nintendo DS™, Sony PlayStation™, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution™ (BSD), FreeBSD, NetBSD, OpenBSD, etc.), Linux distributions (e.g., Red Hat™, Ubuntu™, Kubuntu™, etc.), IBM OS/2™, Microsoft Windows™ (XP, Vista/7/8, etc.), Apple iOS®, Google Android™, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero™, Metro™, etc.), Unix X-Windows, web interface libraries (e.g., ActiveX™, Java™, Javascript™, AJAX™, HTML, Adobe Flash™, etc.), or the like.

In some embodiments, the computer system 401 may implement a web browser 418 stored program component. The web browser may be a hypertext viewing application, such as Microsoft™ Internet Explorer™, Google Chrome™, Mozilla Firefox™, Apple Safari™, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange™, or the like. The mail server may utilize facilities such as ASP, ActiveX, ANSI C++/C#, Microsoft .NET™, CGI scripts, Java™, JavaScript™, PERL™, PHP™, Python™, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail™, Microsoft Entourage™, Microsoft Outlook™, Mozilla Thunderbird™, etc.

In some embodiments, computer system 401 may store user/application data 421, such as the data, variables, records, etc. as described in this disclosure. Such databases may be implemented as fault-tolerant, relational, scalable, secure databases such as Oracle™ or Sybase™. Alternatively, such databases may be implemented using standardized data structures, such as an array, hash, linked list, struct, structured text file (e.g., XML), table, or as object-oriented databases. Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

### ADVANTAGE OF THIS INVENTION

The invention uses a multimodal approach. It receives one or more user inputs in various modes, combines them to get a fused result indicative of the intent of the user. Furthermore, the user can directly dynamically interact with the multimodal content rendered and with a hassle free accurate content extraction.

We claim:

1. A method of multi-modal search key based multimedia content extraction, the method comprising:
receiving, by a search key generator device, a multimedia content search request for a multimedia content, wherein the multimedia content search request comprises multimodal inputs in one or more fragments and wherein the one or more fragments comprises at least one of a text fragment, an image fragment, an audio fragment and a video fragment;
interleaving, by the search key generator device, the one or more fragments to a composite fragment by removing overlapping content from the one or more fragments;
tagging, by the search key generator device, the composite fragment to one or more attributes associated with the multimedia content based on a deep-learning of a context associated with the composite fragment;
identifying, by the search key generator device, from a multimedia content database a correlation between the composite fragment and the multimedia content based on the context, wherein the multimedia content is stored in the multimedia content database, and wherein searching for the correlation comprises comparing the context of the composite fragment to a context of the multimedia content; and
extracting, by the search key generator device, the multimedia content identified from the multimedia content database based on comparing the context of the composite fragment to the context of the multimedia content.

2. The method of claim 1, wherein one of the multimodal inputs further acts as a modifier to the multimedia content search request.

3. The method of claim 1, wherein the one or more attributes associated with the multimedia content comprises at least one of a name, a name of a place, a color, a verb, and an adjective.

4. The method of claim 1, wherein the deep learning further comprises:
determining the one or more attributes associated with the multimedia content;
populating the multimedia content database based on the one or more attributes;
assigning a common label to the composite fragment based on the common context;
denominating weightages to the one or more fragments in the composite fragment based on the multimedia content search request, the attributes and the context; and
altering the weightages based on receiving the one of the multimodal inputs multimodal inputs as modifier.

5. The method of claim 1, wherein extraction comprises formatting the multimedia content extracted, wherein formatting further comprises at least synchronizing the audio fragment with the video fragment, and associating the text format and the image format to the synchronized audio format and video format.

6. A search key generator device for recommending products to a user comprising:
a processor; and
a memory communicatively coupled to the processor, wherein the memory stores processor executable instructions, which on execution causes the processor to:
receive a multimedia content search request for a multimedia content, wherein the multimedia content search request comprises multimodal inputs in one or more fragments and wherein the one or more fragments comprises at least one of a text fragment, an image fragment, an audio fragment and a video fragment;
interleave the one or more fragments to a composite fragment by removing overlapping content from the one or more fragments;
tag the composite fragment to one or more attributes associated with the multimedia content based on a deep-learning of a context associated with the composite fragment;
identify from a multimedia content database a correlation between the composite fragment and the multimedia content based on the context, wherein the multimedia content is stored in the multimedia content database, and wherein searching for the correlation comprises comparing the context of the composite fragment to a context of the multimedia content; and
extract the multimedia content identified from the multimedia content database based on comparing the context of the composite fragment to the context of the multimedia content.

7. The search key generator device of claim 6, wherein one of the multimodal inputs further acts as a modifier to the multimedia content search request.

8. The search key generator device of claim 6, wherein the one or more attributes associated with the multimedia content comprises at least one of a name, a name of a place, a color, a verb, and an adjective.

9. The search key generator device of claim 6, wherein the deep learning further comprises:
determining the one or more attributes associated with the multimedia content;
populating the multimedia content database based on the one or more attributes;
assigning a common label to the composite fragment based on the common context;
denominating weightages to the one or more fragments in the composite fragment based on the multimedia content search request, the attributes and the context; and
altering the weightages based on receiving the one of the multimodal inputs multimodal inputs as modifier.

10. The search key generator device of claim 6, wherein extraction comprises formatting the multimedia content extracted, wherein formatting further comprises at least synchronizing the audio fragment with the video fragment, and associating the text format and the image format to the synchronized audio format and video format.

11. A non-transitory computer-readable storage medium having stored thereon, a set of computer-executable instructions for causing a computer comprising one or more processors to perform steps comprising:
receiving, by a search key generator device, a multimedia content search request for a multimedia content, wherein the multimedia content search request comprises multimodal inputs in one or more fragments and wherein the one or more fragments comprises at least one of a text fragment, an image fragment, an audio fragment and a video fragment;
interleaving, by the search key generator device, the one or more fragments to a composite fragment by removing overlapping content from the one or more fragments;
tagging, by the search key generator device, the composite fragment to one or more attributes associated with the multimedia content based on a deep-learning of a context associated with the composite fragment;
identifying, by the search key generator device, from a multimedia content database a correlation between the composite fragment and the multimedia content based on the context, wherein the multimedia content is stored in the multimedia content database, and wherein searching for the correlation comprises comparing the context of the composite fragment to a context of the multimedia content; and
extracting, by the search key generator device, the multimedia content identified from the multimedia content database based on comparing the context of the composite fragment to the context of the multimedia content.
